(19) United States
(12) Patent Application Publication
(10) Pub. No.: US 2022/0212665 A1
(43) Pub. Date: Jul. 7, 2022

(54) DRIVER ASSISTANCE DEVICE

(71) Applicant: TOYOTA JIDOSHA KABUSHIKI KAISHA, Toyota-shi (JP)

(72) Inventor: Takaaki TANAKA, Susono-shi (JP)

(21) Appl. No.: 17/565,530

(22) Filed: Dec. 30, 2021

(30) Foreign Application Priority Data
Jan. 7, 2021 (JP) 2021-001443

(51) Int. Cl. B60W 30/14; B60W 60/00

(52) U.S. Cl. CPC B60W 30/146; B60W 60/001; B60W 2720/10; B60W 2552/05; B60W 2520/10; B60W 2555/60; B60W 2710/18

(57) ABSTRACT

The driver assistance device includes a processor configured to determine an end point of a section in which automated driving can be continued if automated driving of a vehicle is performed, set a target speed of the vehicle at the end point based on road information of a vicinity of the end point, and control operation of the vehicle so that a speed of the vehicle becomes the target speed at the end point. If an arrival point requiring braking of the vehicle is present beyond the end point, the processor is configured to calculate the target speed based on a distance from the end point to the arrival point.

### FIELD

The present disclosure relates to a driver assistance device.

### BACKGROUND

In recent years, a vehicle capable of automated driving under predetermined conditions has been being developed. In such a vehicle, as described in PTLs 1 to 5, at the time of the end of the automated driving, the driving operation of the vehicle is handed over from the system to the driver and automated driving shifts to manual driving.

In the automated driving assistance system described in PTL 1, the target vehicle speed when handing over the driving operation to the driver is set in accordance with the operation of the accelerator by the driver.

### CITATIONS LIST

### Patent Literature

[PTL 1] Japanese Unexamined Patent Publication No. 2015-182525
[PTL 2] WO2018/159399
[PTL 3] WO2017/203691
[PTL 4] Japanese Unexamined Patent Publication No. 2004-142686
[PTL 5] Japanese Unexamined Patent Publication No. 2020-097380

### SUMMARY

### Technical Problem

However, in this case, since the driver can freely set the target vehicle speed, the driving operation is liable to be handed over to the driver at a vehicle speed not suitable for the traffic situation of the surroundings.

In consideration of the above problem, an object of the present disclosure is to realize a vehicle speed suitable for the traffic situation of the surroundings at the time of shifting from automated driving to manual driving.

### Solution to Problem

The summary of the present disclosure is as follows.

(1) A driver assistance device comprising: an end point determining part configured to determine an end point of a section in which automated driving can be continued if automated driving of a vehicle is performed; a target speed setting part configured to set a target speed of the vehicle at the end point based on road information of a vicinity of the end point; and a vehicle control part configured to control operation of the vehicle so that a speed of the vehicle becomes the target speed at the end point, wherein if an arrival point requiring braking of the vehicle is present beyond the end point, the target speed setting part is configured to calculate the target speed based on a distance from the end point to the arrival point.

(2) The autonomous driving system described in above (1), wherein if a deceleration point where a speed limit is lowered is before the end point, the target speed setting part is configured to determine the target speed based on a distance from the deceleration point to the end point.

(3) The autonomous driving system described in above (1) or (2), wherein if a deceleration point where a speed limit is lowered is present before the end point and the arrival point is present beyond the end point, the target speed setting part is configured to calculate a first speed based on a distance from the end point to the arrival point, calculate a second speed based on a distance from the deceleration point to the end point, and set a lower speed of the first speed and the second speed as the target speed.

(4) The autonomous driving system described in any one of above (1) to (3), wherein the target speed setting part is configured to set a speed limit at the end point as the target speed, if the end point is an entrance to a service area or a parking area or an exit of a vehicle-only road.

(5) The autonomous driving system described in any one of above (1) to (4), wherein the target speed setting part is configured to set a speed limit at the end point as the target speed if the end point is set inside of a turnoff road turning off from a thru lane of a vehicle-only road.

### Advantageous Effects of Invention

According to the present disclosure, it is possible to realize a vehicle speed suitable for the traffic situation of the surroundings at the time of shifting from automated driving to manual driving.

### BRIEF DESCRIPTION OF DRAWINGS

FIG. 1 is a view showing one example of the configuration of a vehicle in which a driver assistance device according to a first embodiment of the present disclosure is provided.

FIG. 2 is a functional block diagram of an ECU of FIG. 1.

FIG. 3 is a view showing an ideal vehicle speed profile when an arrival point requiring braking of the vehicle is present beyond an end point.

FIG. 4 is a graph showing a relationship between a distance from the end point to the arrival point and a target speed at the end point.

FIG. 5 is a flow chart showing a control routine of processing for setting a target speed in the first embodiment.

FIG. 6 is a view showing an ideal vehicle speed profile when a deceleration point where the speed limit is lowered is present before the end point.

FIG. 7 is a flow chart showing a control routine of processing for setting a target speed in a second embodiment.

FIG. 8 is a view showing a first speed and a second speed calculated when the deceleration point is present before the end point and the arrival point is present beyond the end point.

FIG. 9A is a flow chart showing a control routine of processing for setting a target speed in a third embodiment.

FIG. 9B is a flow chart showing a control routine of processing for setting a target speed in a third embodiment.

FIG. 10 is a flow chart showing a control routine of processing for setting a target speed in a fourth embodiment.

### DESCRIPTION OF EMBODIMENTS

Below, embodiments of the present disclosure will be explained in detail while referring to the drawings. Note that, in the following explanation, similar component elements will be assigned the same reference notations.

### First Embodiment

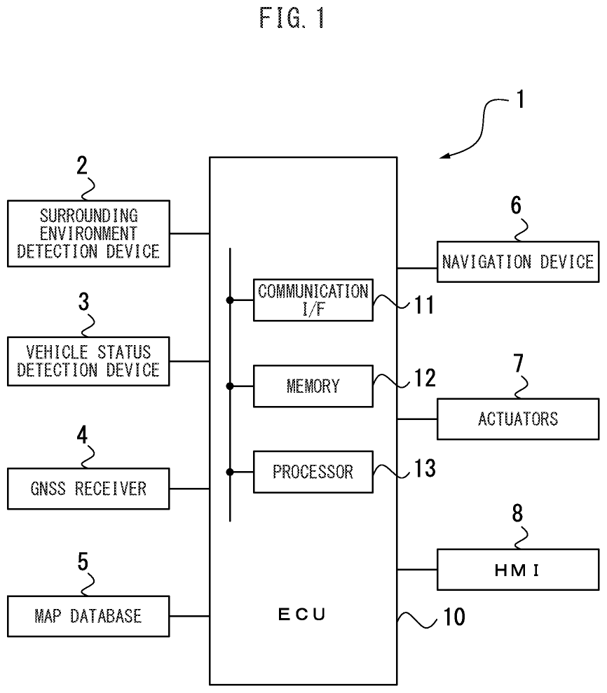

First, referring to FIG. 1 to FIG. 5, a first embodiment of the present disclosure will be explained.

<Explanation of Vehicle as Whole>

FIG. 1 is a view showing one example of the configuration of a vehicle 1 in which a driver assistance device according to the first embodiment of the present disclosure is provided. In the vehicle 1, either manual driving or automated driving is performed for operation of the vehicle 1. In the manual driving, all of the acceleration, steering, and braking of the vehicle 1 are controlled by the driver of the vehicle 1, while in the automated driving, a part or all of the acceleration, steering, and braking of the vehicle 1 are controlled automatically. Automated driving is also called “self driving”.

As shown in FIG. 1, the vehicle 1 is provided with a surrounding environment detection device 2, a vehicle status detection device 3, a GNSS receiver 4, a map database 5, a navigation device 6, actuators 7, a human machine interface (HMI) 8, and an electronic control unit (ECU) 10. The surrounding environment detection device 2, the vehicle status detection device 3, the GNSS receiver 4, the map database 5, the navigation device 6, the actuators 7, and the HMI 8 are connected through an internal vehicle network based on the CAN (Controller Area Network) or other standard to be able to communicate with the ECU 10.

The surrounding environment detection device 2 detects the surrounding environment of the vehicle 1. The surrounding environment of the vehicle 1 includes objects in the surroundings of the vehicle 1 (other vehicles, signs, white lines, fallen objects, etc.), the weather of the surroundings of the vehicle 1, etc. The surrounding environment detection device 2, for example, includes a camera, a LIDAR (laser imaging detection and ranging), a milliwave radar, an ultrasonic sensor (sonar), a rain sensor, a light sensor, etc. The output of surrounding environment detection device 2 are transmitted to the ECU 10.

The vehicle status detection device 3 detects state quantities of the vehicle 1. The state quantities of the vehicle 1 include a speed (vehicle speed), an acceleration, a steering angle, a yaw rate, etc. of the vehicle 1. The vehicle status detection device 3, for example, includes a vehicle speed sensor, an acceleration sensor, a steering angle sensor, a yaw rate sensor, etc. The output of the vehicle status detection device 3 is transmitted to the ECU 10.

The GNSS receiver 4 captures a plurality of satellites and receives signals sent from the satellites. The GNSS receiver 4 calculates the distances to the satellites based on the differences from the times of transmission and times of reception of the signals and detects the current position of the vehicle 1 (for example, the latitude and longitude of the vehicle 1) based on the distances to the satellites and positions of the satellites (orbit information). The output of the GNSS receiver 4 is transmitted to the ECU 10. Note that, “GNSS” (global navigation satellite system) is the general term for the GPS of the U.S., GLONASS of Russia, Galileo of Europe, QZSS of Japan, BeiDou of China, IRNSS of India, and other satellite position measurement systems. Therefore, the GNSS receiver 4 includes a GPS receiver.

The map database 5 stores map information. The map information stored in the map database 5 may be periodically updated using communication of the vehicle 1 with the outside, SLAM (simultaneous localization and mapping) technology, etc. The ECU 10 acquires the map information from the map database 5.

The navigation device 6 sets the driving route of the vehicle 1 to the destination based on the current position of the vehicle 1 detected by the GNSS receiver 4, the map information of the map database 5, input by the driver, etc. The driving route set by the navigation device 6 is transmitted to the ECU 10. Note that, the GNSS receiver 4 and the map database 5 may be incorporated into the navigation device 6.

The actuators 7 make the vehicle 1 operate. For example, the actuators 7 include a drive device for acceleration of the vehicle 1 (at least one of an engine and a motor), a brake actuator for braking of the vehicle 1, a steering motor for steering the vehicle 1, etc. The ECU 10 controls the actuators 7 for performing automated driving of the vehicle 1.

The HMI 8 is an input/output device for input and output of information between the driver and the vehicle 1. The HMI 8, for example, has a display for displaying information, a speaker for generating sound, an operating button or a touch screen for the driver to operate to input commands, a microphone for receiving voice commands, etc. The output of the ECU 10 is transmitted through the HMI 8 to the driver, while the input from the driver is transmitted through the HMI 8 to the ECU 10.

The ECU 10 performs various types of control of the vehicle. As shown in FIG. 1, the ECU 10 is provided with a communication interface 11, a memory 12, and a processor 13. The communication interface 11 and the memory 12 are connected to the processor 13 through signal lines. Note that, in the present embodiment, a single ECU 10 is provided, but a plurality of ECUs may be provided for the respective functions.

The communication interface 11 has an interface circuit for connecting the ECU 10 to the internal vehicle network. The ECU 10 is connected through the communication interface 11 to the surrounding environment detection device 2, the vehicle status detection device 3, the GNSS receiver 4, the map database 5, the navigation device 6, the actuators 7, and the HMI 8.

The memory 12, for example, has a volatile semiconductor memory and a nonvolatile semiconductor memory. The memory 12 stores programs, data, etc. used when various processing are performed by the processor 13.

The processor 13 has one or more CPUs (central processing unit) and their peripheral circuits. Note that, the processor 13 may further have a processing circuit such as a logic unit or an arithmetic unit.

<Driver Assistance Device>

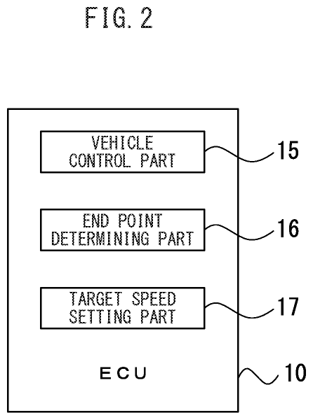

In the present embodiment, the ECU 10 functions as a driver assistance device for assisting driving of the vehicle 1. FIG. 2 is a functional block diagram of the ECU 10 of FIG. 1. In the present embodiment, the ECU 10 has a vehicle control part 15, an end point determining part 16, and a target speed setting part 17. The vehicle control part 15, the end point determining part 16, and the target speed setting part 17 are functional modules realized by programs stored in the memory 12 of the ECU 10 being run by the processor 13 of the ECU 10.

In the present embodiment, if the driver selects the automated driving mode as the driving mode of the vehicle 1, automated driving of the vehicle 1 is performed under predetermined conditions. The vehicle control part 15 controls the operation of the vehicle 1 when automated driving of the vehicle 1 is performed. Specifically, the vehicle control part 15 uses the actuators 7 to at least partially control the acceleration, the steering, and the braking of the vehicle 1 so that the vehicle 1 runs along a predetermined driving route.

The end point determining part 16 determines the end point of the section where automated driving can be continued if automated driving of the vehicle 1 is performed. Information regarding whether or not automated driving can be performed is registered in advance in the map database 5 for each location. In the present embodiment, automated driving can be performed in a section which is a vehicle-only road where only vehicles are permitted to run and which a high precision map is prepared. The high precision map includes road shapes, white lines, and other information.

In order to enable automated driving to be smoothly ended, the shift from automated driving to manual driving must be completed before the vehicle 1 reaches the end point. For this reason, a predetermined section right before the end point is set as a driving shift section for handing off the driving operation of the vehicle 1 to the driver. In the driving shift section, the driver is required to shift from automated driving to manual driving through the HMI 8, etc. provided at the vehicle 1, when manual driving is started by the driver, the automated driving ends.

However, if the speed of the vehicle 1 when manual driving is started is not suitable for the traffic situation of the road in the vicinity of the end point, it will become difficult for the driver to control the operation of the vehicle 1 along with the flow of traffic of the surroundings. For this reason, the target speed setting part 17 sets the target speed of the vehicle 1 at the end point based on the road information in the vicinity of the end point, and the vehicle control part 15 controls the operation of the vehicle 1 so that the speed of the vehicle 1 becomes the target speed at the end point.

For example, if an arrival point requiring braking of the vehicle 1 is present beyond the end point, the driver makes the vehicle 1 gradually decelerate toward the arrival point after the start of manual driving. At this time, if the speed of the vehicle 1 at the end point is low regardless of the distance from the end point to the arrival point being long, the vehicle 1 is liable to interfere with the flow of traffic of the surroundings. On the other hand, if the speed of the vehicle 1 at the end point is high regardless of the distance from the end point to the arrival point being short, it is necessary to increase the degree of deceleration of the vehicle 1 at the manual driving and the behavior of the vehicle 1 is liable to become unstable.

Therefore, in the present embodiment, if the arrival point requiring braking of the vehicle 1 is present beyond the end point, the target speed setting part 17 calculates the target speed of the vehicle 1 at the end point based on the distance from the end point to the arrival point. By doing this, it is possible to realize a vehicle speed suitable for the traffic situation in the surroundings at the time of shifting from automated driving to manual driving.

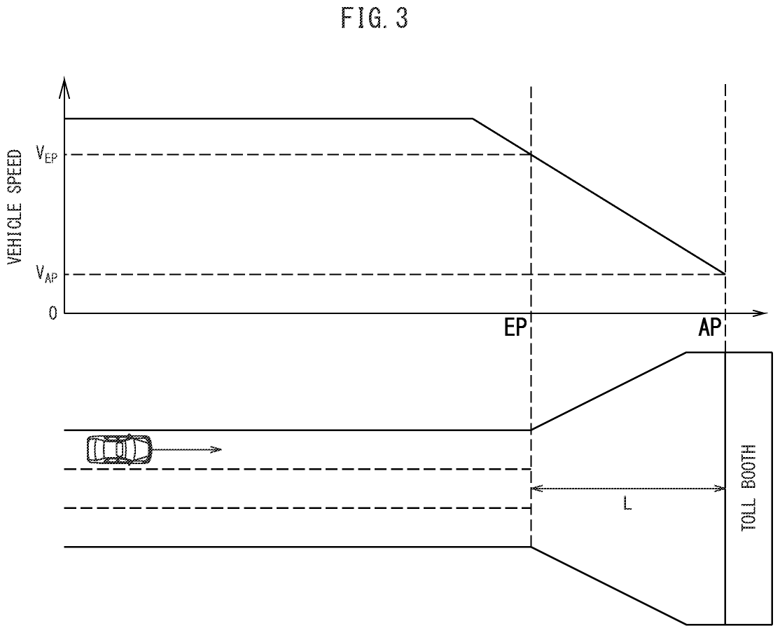

FIG. 3 is a view showing an ideal vehicle speed profile when the arrival point requiring braking of the vehicle 1 is present beyond the end point. In the example of FIG. 3, the end point EP is set on the thru lanes of the vehicle-only road and there is a toll booth (thru lane toll booth) present beyond the end point EP as the arrival point AP requiring braking of the vehicle 1. Between the end point EP and the toll booth, there is a broad section of no lanes. The end point EP is set at the end of the road having white lines.

In this case, the target speed setting part 17 calculates the target speed V_{EP} of the vehicle 1 at the end point EP based on the target speed Y_{AP} of the vehicle 1 at the arrival point and the distance L from the end point EP to the arrival point AP. For example, the target speed setting part 17 calculates the target speed V_{EP} at the end point EP so that the speed of the vehicle 1 becomes a predetermined speed at the arrival point AP (target speed V_{AP} at arrival point) if making the vehicle 1 decelerate from the end point EP to the arrival point AP by the constant deceleration “a”.

That is, the target speed setting part 17 solves the quadratic equation of the following formula (1) to calculate the required time “t” from the end point EP to the arrival point AP and enters the required time “t” into the following formula (2) to calculate the target speed V_{EP} at the end point EP.

L=(1000/3600)·V_{AP}·t−(½)·a·t² (1)

(1000/3600)·V_{EP}=(1000/3600)·V_{AP}−a·t (2)

In the above formulas (1) and (2), the unit of the distance L is “m”, the units of the target speed V_{AP} at the arrival point AP and the target speed V_{EP} at the end point EP are “km/h”, the unit of the deceleration “a” is “m/s²”, and the unit of the required time “t” is seconds. Note that, 1000/3600 is a coefficient for converting the units of the target speeds V_{AP} and V_{EP} from “km/h” to “m/s”.

The target speed V_{AP} of the vehicle 1 at the arrival point AP is determined in advance and for example is set to 0 km/h to 30 km/h. As a specific example, if the arrival point AP is a toll booth, the target speed V_{AP} of the vehicle 1 is set to 20 km/h. Note that, if it is expected that, at the toll booth, an automatic toll collecting system such as an ETC (Electronic Toll Collection) system will not be utilized (for example, if an automatic toll collecting system is not provided at the toll booth, if the vehicle 1 is not equipped with an ETC card, etc.), the target speed V_{AP} of the vehicle 1 may be set to 0 km/h. Further, as another specific example of the arrival point requiring braking of the vehicle 1, a traffic light, etc. may be mentioned. If the arrival point is a traffic light, the target speed V_{AP} of the vehicle 1 is for example set to 0 km/h.

The deceleration “a” is determined in advance and is set to a predetermined negative value so as to correspond to a natural brake operation by the driver. The deceleration “a” is, for example, set to −0.5 m/s² to −2.5 m/s², preferably −1.0 m/s².

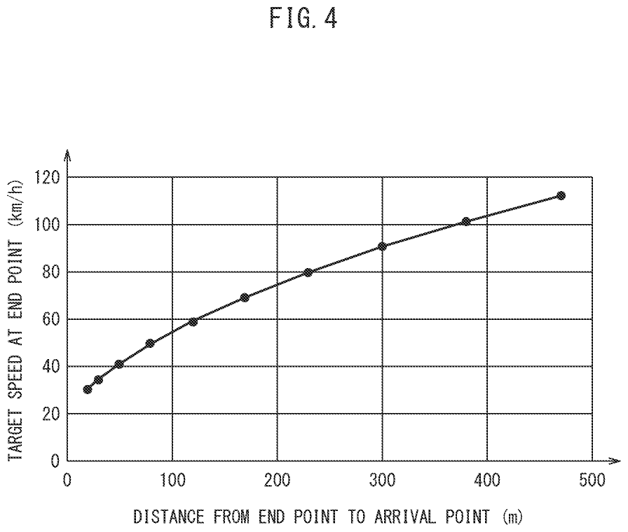

FIG. 4 is a graph showing the relationship between the distance from the end point to the arrival point and the target speed at the end point. In FIG. 4, the target speed V_{AP} of the vehicle 1 at the arrival point is set to 20 km/h, the deceleration “a” is set to −1.0 m/s², and the above formulas (1) and (2) are used to calculate the target speed V_{EP} at the end point of the vehicle 1. As shown in FIG. 4, the longer the distance from the end point to the arrival point, the higher the target speed at the end point.

<Processing for Setting Target Speed>

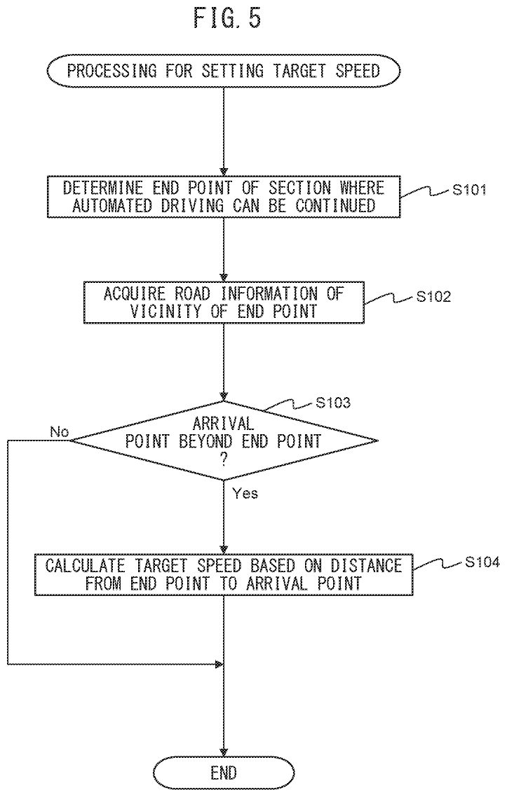

Below, referring to the flow chart of FIG. 5, the control for setting the target speed of the vehicle 1 at the end point will be explained in detail. FIG. 5 is a flow chart showing the control routine of processing for setting the target speed in the first embodiment. The present control routine is executed by the ECU 10 at a predetermined timing after automated driving of the vehicle 1 is started.

First, at step S101, the end point determining part 16 determines the end point of the section where automated driving can be continued. For example, the end point determining part 16 compares the driving route set by the navigation device 6 with the section where automated driving can be performed registered in the map database 5 to determine the end point of the section where automated driving can be continued.

Next, at step S102, the target speed setting part 17 acquires the road information of the vicinity of the end point from the map database 5. The “vicinity of the end point” means, for example, positions which are on the driving route and have a distance to the end point of equal to or less than a predetermined value (for example, 200 to 800 m). Further, the road information includes the presence of any arrival point requiring braking of the vehicle 1. Note that, the target speed setting part 17 may acquire the road information of the vicinity of the end point from the output of the surrounding environment detection device 2 (for example the camera) when the vehicle 1 approaches the driving shift section.

Next, at step S103, the target speed setting part 17 judges based on the road information of the vicinity of the end point whether the arrival point requiring braking of the vehicle 1 is present beyond the end point. If it is judged that the arrival point is present beyond the end point, the present control routine proceeds to step S104.

At step S104, the target speed setting part 17 calculates the target speed of the vehicle 1 at the end point based on the distance from the end point to the arrival point. For example, the target speed setting part 17 uses the above formulas (1) and (2) to calculate the target speed of the vehicle 1 at the end point. After step S104, the present control routine ends.

Note that, the target speed setting part 17 may calculate the target speed of the vehicle 1 at the end point so that the speed of the vehicle 1 becomes a predetermined speed at the arrival point predicated on the deceleration rate of the vehicle 1 changing linearly or in stages (in steps) in the span from the end point to the arrival point. Further, the target speed setting part 17 may use a map showing the relationship between the distance from the end point to the arrival point and the target speed of the vehicle 1 at the end point to calculate the target speed of the vehicle 1 at the end point. In this case, the map is created so that the target speed of the vehicle 1 at the end point becomes higher the longer the distance from the end point to the arrival point.

On the other hand, if at step S103 it is judged that arrival point is not present beyond the end point, the present control routine ends. In this case, the speed of the vehicle 1 is controlled in accordance with the traffic situation in the surroundings, etc. until the automated driving of the vehicle 1 ends. Note that, if the judgment at step S103 is negative, the target speed of the vehicle 1 at the end point may be set to a predetermined value (for example, the speed limit at the end point).

### Second Embodiment

The driver assistance device according to a second embodiment, except for the points explained below, is basically similar in configuration and control to the driver assistance device according to the first embodiment. For this reason, below, the second embodiment of the present disclosure will be explained focusing on parts different from the first embodiment.

If the end point of the section where automated driving can be continued is set to the vicinity of the end of a vehicle-only road etc., the deceleration point where the speed limit is lowered is sometimes present before the end point. In such a situation, usually other vehicles in the surroundings gradually decelerate after passing the deceleration point. For this reason, the target speed at the end point is preferably set so that the vehicle 1 gradually decelerates from the deceleration point toward the end point.

Therefore, in the second embodiment, if the deceleration point where the speed limit is lowered is present before the end point, the target speed setting part 17 calculates the target speed of the vehicle 1 at the end point based on the distance from the deceleration point to the end point. By doing this, at the time of shifting from automated driving to manual driving, it is possible to realize a vehicle speed suitable for the traffic situation of the surroundings.

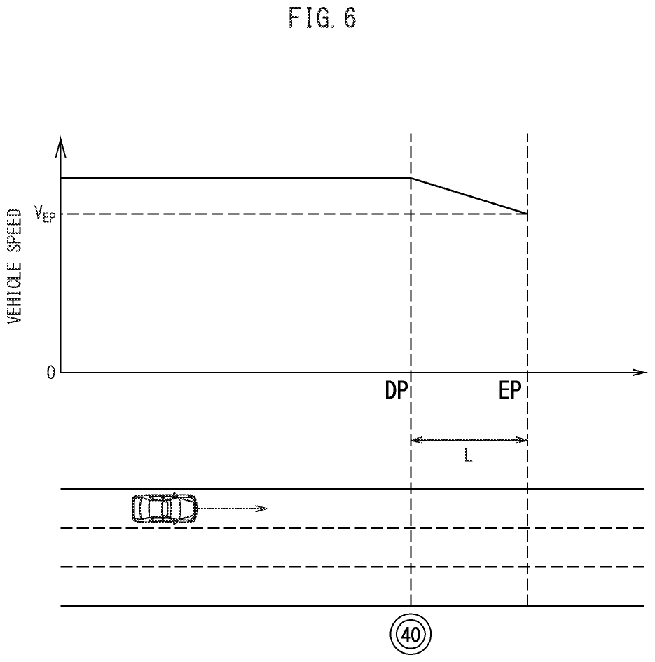

FIG. 6 is a view showing an ideal vehicle speed profile when the deceleration point where the speed limit is lowered is present before the end point. In the example of FIG. 6, the end point EP is set on the thru lanes of the vehicle-only road, and as the deceleration point DP where the speed limit is lowered, a speed limit sign is present before the end point EP. The speed limit is determined by the maximum legal speed in a location with no speed limit sign and is determined by a speed limit sign in a location having a speed limit sign. In the example of FIG. 6, the speed limit to the deceleration point is the maximum legal speed (for example, 100 km/h), while the speed limit from the deceleration point and on is the 40 km/h set by the speed limit sign.

In this case, the target speed setting part 17 calculates the target speed V_{EP} of the vehicle 1 at the end point EP based on the speed Vᵢₙ of the vehicle 1 when deceleration of the vehicle 1 is started at the deceleration point DP (below, referred to as the “deceleration start speed”) and the distance L from the deceleration point DP to the end point EP. For example, the target speed setting part 17 calculates the target speed V_{EP} of the vehicle 1 at the end point EP so that the vehicle 1 decelerates from the deceleration point DP to the end point EP by a constant deceleration “a”.

That is, the target speed setting part 17 solves the quadratic equation of the following formula (3) to calculate the required time “t” from the deceleration point DP to the end point EP and enters the required time “t” into the following formula (4) to calculate the target speed V_{E}p at the end point EP.

L=(1000/3600)·Vᵢₙ·t+(½)·a·t² (3)

(1000/3600)·V_{EP}=(1000/3600)·Vᵢₙ+a·t (4)

In the above formulas (3) and (4), the unit of the distance L is “m”, the units of the deceleration start speed Vᵢₙ and the target speed V_{EP} of the end point EP are “km/h”, the unit of the deceleration “a” is “m/s²”, and the unit of the required time “t” is seconds. Note that, 1000/3600 is a coefficient for converting the units of the deceleration start speed Vᵢₙ and the target speed V_{EP} from “km/h” to “m/s”.

The deceleration start speed Vᵢₙ is determined in advance and, for example, is set to the legal speed at the vehicle-only road (for example, 100 km/h). The deceleration “a” is determined in advance and, for example, is set to a predetermined negative value so as to correspond to engine braking with the accelerator off. The deceleration “a” is, for example, set to −0.3 m/s² to −1.0 m/s², preferably −0.5 m/s².

<Processing for Setting Target Speed>

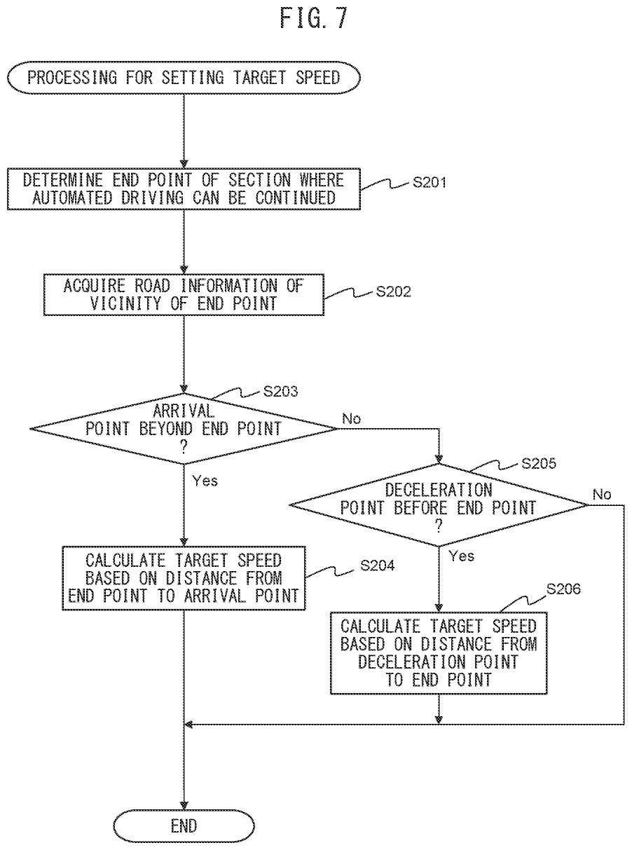

FIG. 7 is a flow chart showing a control routine of processing for setting the target speed in the second embodiment. The present control routine is executed by the ECU 10 at a predetermined timing after automated driving of the vehicle 1 is started.

Steps S201 to S204 are performed in the same way as steps S101 to S104 of FIG. 5. If at step S103 it is judged that the arrival point requiring braking of the vehicle 1 is not present beyond the end point, the present control routine proceeds to step S205.

At step S205, the target speed setting part 17 judges whether the deceleration point where the speed limit is lowered is present before the end point based on the road information of the vicinity of the end point. If it is judged that the deceleration point is present before the end point, the present control routine proceeds to step S206.

At step S206, the target speed setting part 17 calculates the target speed of the vehicle 1 at the end point based on the distance from the deceleration point to the end point. For example, the target speed setting part 17 uses the above formulas (3) and (4) to calculate the target speed of the vehicle 1 at the end point. After step S206, the present control routine ends.

Note that, the target speed setting part 17 may calculate the target speed of the vehicle 1 at the end point predicated on the deceleration rate of the vehicle 1 changing linearly or in stages (in steps) in the span from the deceleration point to the end point. Further, the target speed setting part 17 may use a map showing the relationship between the distance from the deceleration point to the end point and the target speed of the vehicle 1 at the end point to calculate the target speed of the vehicle 1 at the end point. In this case, the map is created so that the target speed of the vehicle 1 at the end point becomes lower the longer the distance from the deceleration point to the end point.

On the other hand, if at step S205 it is judged that the deceleration point is not present before the end point, the present control routine ends. In this case, the speed of the vehicle 1 is controlled in accordance with the traffic situation of the surroundings, etc. until the automated driving of the vehicle 1 ends. Note that, if the judgment of step S105 is negative, the target speed of the vehicle 1 at the end point may be set to a predetermined value (for example, the speed limit at the end point).

### Third Embodiment

The driver assistance device according to a third embodiment, except for the points explained below, is basically similar in configuration and control to the driver assistance device according to the first embodiment. For this reason, below, the third embodiment of the present disclosure will be explained focusing on parts different from the first embodiment.

If the end point of the section where automated driving can be continued is set to the vicinity of the end of the vehicle-only road etc., sometimes the arrival point requiring braking of the vehicle 1 will be present beyond the end point and the deceleration point where the speed limit is lowered will be present before the end point. In this case, in order to better match the flow of traffic in the surroundings, as the target speed of the vehicle 1 at the end point, it is preferable to select the lower speed of the speed calculated considering the arrival point and the speed calculated considering the deceleration point.

Therefore, in the third embodiment, if the deceleration point where the speed limit is lowered is present before the end point and the arrival point requiring braking of the vehicle 1 is present beyond the end point, the target speed setting part 17 calculates a first speed based on the distance from the end point to the arrival point, calculates a second speed based on the distance from the deceleration point to the end point, and sets the lower speed of the first speed and the second speed as the target speed. By doing this, even if the deceleration point and arrival point are present before and after the end point, it is possible to realize a vehicle speed suitable for the traffic situation of the surroundings when shifting from automated driving to manual driving.

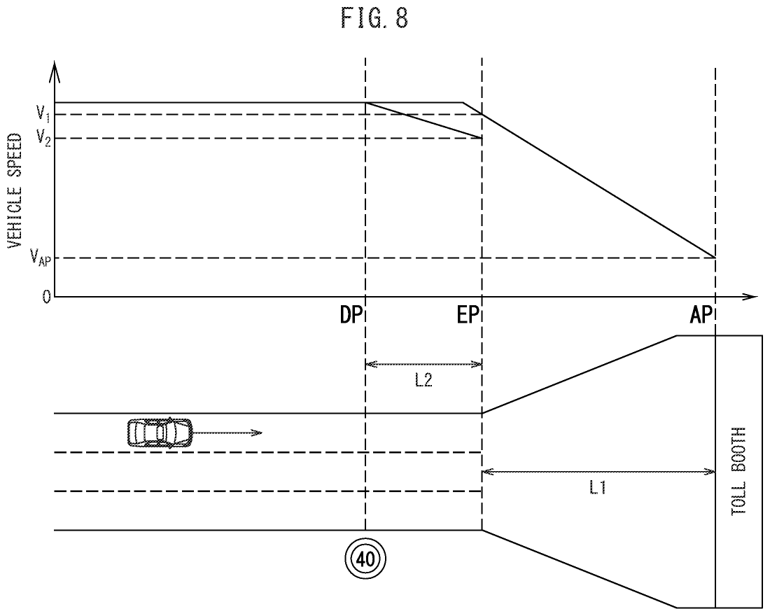

FIG. 8 is a view showing the first speed and the second speed calculated when the deceleration point is present before the end point and the arrival point is present beyond the end point. For example, the target speed setting part 17 uses the above formulas (1) and (2) to calculate the first speed V₁ based on a distance L1 from the end point EP to the arrival point AP. In this case, in the above formula (1), instead of the distance L, the distance L1 is used, while in the above formula (2), instead of the target speed V_{E}p, the first speed V₁ is used. Further, the target speed setting part 17 uses the above formulas (3) and (4) to calculate the second speed V₂ based on a distance L2 from the deceleration point DP to the end point EP. In this case, in the above formula (3), instead of the distance L, the distance L2 is used, while in the above formula (4), instead of the target speed V_{E}p, the second speed V₂ is used.

In the example of FIG. 8, the second speed V₂ calculated based on the distance L2 from the deceleration point DP to the end point EP is lower than the first speed V₁ calculated based on the distance L1 from the end point EP to the arrival point AP. For this reason, the second speed V₂ is set as the target speed of the vehicle 1 at the end point EP. As will be understood from FIG. 8, the longer the distance from the end point EP to the arrival point AP, the higher the possibility of the second speed V₂ being set as the target speed of the vehicle 1 at the end point EP.

<Processing for Setting Target Speed>

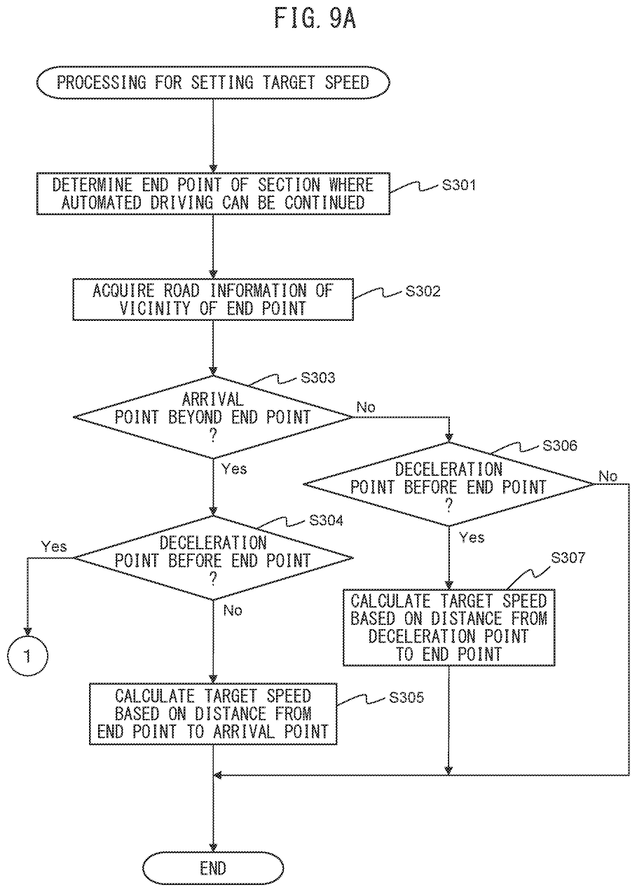

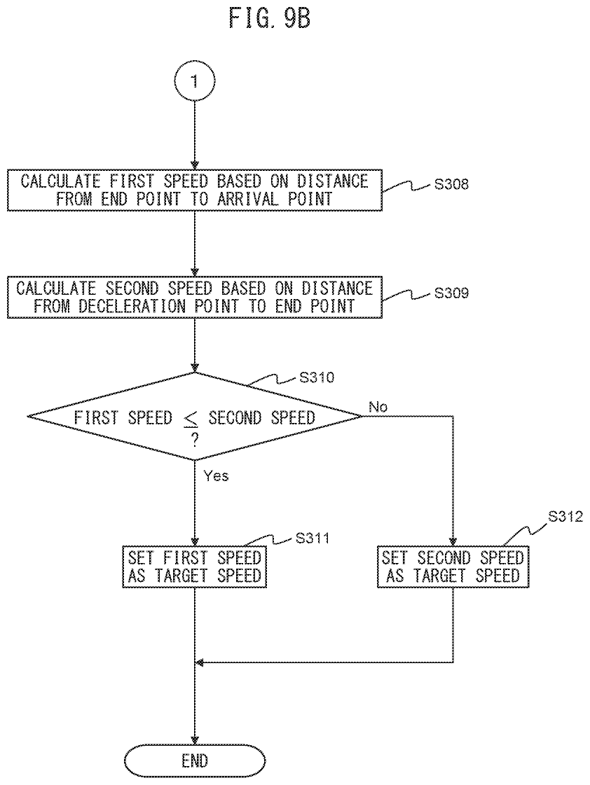

FIGS. 9A and 9B are flow charts showing the control routine of processing for setting the target speed in the third embodiment. The present control routine is executed by the ECU 10 at a predetermined timing after automated driving of the vehicle 1 is started.

Steps S301 to S303 are performed in the same way as steps S101 to S103 of FIG. 5. If at step S303 it is judged that the arrival point requiring braking of the vehicle 1 is present beyond the end point, the present control routine proceeds to step S304.

At step S304, the target speed setting part 17 judges based on the road information of the vicinity of the end point whether the deceleration point where the speed limit is lowered is present before the end point. If it is judged that the deceleration point is not present before the end point, the present control routine proceeds to step S305.

At step S305, in the same way as step S104 of FIG. 5, the target speed setting part 17 calculates the target speed based on the distance from the end point to the arrival point. After step S305, the present control routine ends.

On the other hand, if at step S304 it is judged that the deceleration point is present before the end point, the present control routine proceeds to step S308. At step S308, the target speed setting part 17 calculates the first speed based on the distance from the end point to the arrival point. For example, the target speed setting part 17 calculates the first speed using the above formulas (1) and (2).

Note that, the target speed setting part 17 may calculate the first speed so that the speed of the vehicle 1 becomes a predetermined speed at the arrival point predicated on the deceleration rate of the vehicle 1 changing linearly or in stages (in steps) in the span from the end point to the arrival point. Further, the target speed setting part 17 may calculate the first speed using a map showing the relationship between the distance from the end point to the arrival point and the first speed. In this case, the map is created so that the first speed becomes lower the longer the distance from the end point to the arrival point.

Next, at step S308, the target speed setting part 17 calculates the second speed based on the distance from the deceleration point to the end point. For example, the target speed setting part 17 calculates the second speed using the above formulas (3) and (4).

Note that, the target speed setting part 17 may calculate the second speed predicated on the deceleration rate of the vehicle 1 changing linearly or in stages (in steps) in the span from the deceleration point to the end point. Further, the target speed setting part 17 may calculate the second speed using a map showing the relationship between the distance from the deceleration point to the end point and the second speed. In this case, the map is created so that the second speed becomes lower the longer the distance from the deceleration point to the end point.

Next, at step S310, the target speed setting part 17 judges whether the first speed is equal to or less than the second speed. If it is judged that the first speed is equal to or less than the second speed, the present control routine proceeds to step S311. At step S311, the target speed setting part 17 sets the first speed as the target speed. After step S311, the present control routine ends.

On the other hand, if at step S310 it is judged that the first speed is higher than the second speed, the present control routine proceeds to step S312. At step S312, the target speed setting part 17 sets the second speed as the target speed. After step S312, the present control routine ends.

Further, if at step S303 it is judged that the arrival point is not present beyond the end point, the present control routine proceeds to step S306 and steps S306 and S307 are performed in the same way as steps S205 and S206 of FIG. 7.

### Fourth Embodiment

The driver assistance device according to a fourth embodiment, except for the points explained below, is basically similar in configuration and control to the driver assistance device according to the first embodiment. For this reason, below, the fourth embodiment of the present disclosure will be explained focusing on parts different from the first embodiment.

As the end point of a section in which automated driving can be continued, sometimes an entrance to a service area (SA) or a parking area (PA) or an exit of vehicle-only road is set. Normally, if a vehicle is driven toward these locations, the speed of the vehicle is controlled using these locations as the target points. For this reason, in the fourth embodiment, the target speed setting part 17 sets the speed limit at the end point as the target speed if the end point is an entrance to a service area or a parking area or an exit of vehicle-only road. By doing this, when shifting from automated driving to manual driving, it is possible to realize a vehicle speed suitable for the traffic situation of the surroundings.

Further, the end point of the section where automated driving can be continued is sometimes set inside a turnoff road (turnoff lane) turning off from the thru lanes of a vehicle-only road. At a turnoff road, the width of the road tends to become narrower, therefore the driver of the vehicle 1 may wish to drive at the speed limit. For this reason, in the fourth embodiment, the target speed setting part 17 sets the speed limit at the end point as the target speed if the end point is set inside of a turnoff road.

<Processing for Setting Target Speed>

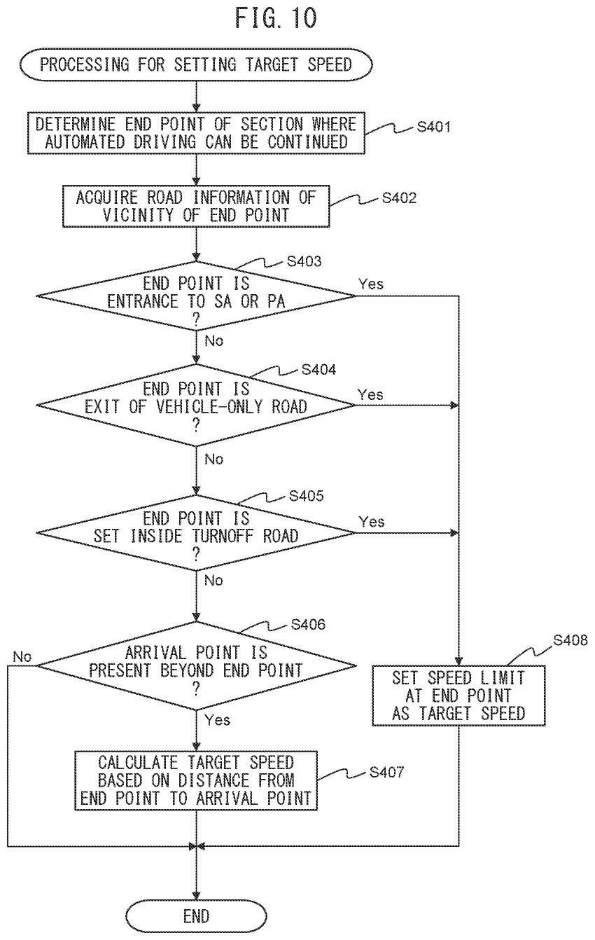

FIG. 10 is a flow chart showing a control routine of processing for setting a target speed in the fourth embodiment. The present control routine is executed by the ECU 10 at a predetermined timing after automated driving of the vehicle 1 is started.

Steps S401 and S402 are performed in the same way as steps S101 and S102 of FIG. 5. After step S402, at step S403, the target speed setting part 17 judges whether the end point is the entrance to a service area or a parking area. If it is judged that the end point is not the entrance to a service area or a parking area, the present control routine proceeds to step S404.

At step S404, the target speed setting part 17 judges whether the end point is an exit of a vehicle-only road. If it is judged that the end point is not an exit of a vehicle-only road, the present control routine proceeds to step S405.

At step S405, the target speed setting part 17 judges whether the end point is set inside a turnoff road. If it is judged that the end point is not set inside a turnoff road, the present control routine proceeds to step S406. Steps S406 and S407 are performed in the same way as steps S103 and S104 of FIG. 5.

On the other hand, if at step S403 it is judged that the end point is an entrance to a service area or a parking area, if at step S404 it is judged that the end point is an exit of a vehicle-only road, or if at step S405 it is judged that the end point is set inside a turnoff road, the present control routine proceeds to step S408. At step S408, the target speed setting part 17 sets the speed limit at the end point as the target speed of the vehicle 1 at the end point. After step S408, the present control routine ends.

Above, preferred embodiments according to the present disclosure were explained, but the present disclosure is not limited to these embodiments and can be corrected and changed in various ways within the language of the claims.

Further, the above embodiments can be worked freely combined. For example, if the second embodiment and the fourth embodiment are combined, in the control routine of FIG. 10, instead of steps S406 and S407, steps S203 to S206 of FIG. 7 are performed.

Further, if the third embodiment and the fourth embodiment are combined, in the control routine of FIG. 10, instead of steps S406 and S407, steps S303 to S312 of FIG. 9A and FIG. 9B are performed.

### REFERENCE SIGNS LIST

1. vehicle
10. electronic control unit (ECU)
15. vehicle control part
16. end point determining part
17. target speed setting part

1. A driver assistance device comprising a processor configured to:
determine an end point of a section in which automated driving can be continued if automated driving of a vehicle is performed;
set a target speed of the vehicle at the end point based on road information of a vicinity of the end point; and
control operation of the vehicle so that a speed of the vehicle becomes the target speed at the end point, wherein
if an arrival point requiring braking of the vehicle is present beyond the end point, the processor is configured to calculate the target speed based on a distance from the end point to the arrival point.

2. The driver assistance device according to claim 1, wherein if a deceleration point where a speed limit is lowered is before the end point, the processor is configured to determine the target speed based on a distance from the deceleration point to the end point.

3. The driver assistance device according to claim 1, wherein if a deceleration point where a speed limit is lowered is present before the end point and the arrival point is present beyond the end point, the processor is configured to calculate a first speed based on a distance from the end point to the arrival point, calculate a second speed based on a distance from the deceleration point to the end point, and set a lower speed of the first speed and the second speed as the target speed.

4. The driver assistance device according to claim 1, wherein the processor is configured to set a speed limit at the end point as the target speed, if the end point is an entrance to a service area or a parking area or an exit of a vehicle-only road.

5. The driver assistance device according to claim 1, wherein the processor is configured to set a speed limit at the end point as the target speed if the end point is set inside of a turnoff road turning off from a thru lane of a vehicle-only road.
